(19) United States
(12) Patent Application Publication
(10) Pub. No.: US 2008/0270412 A1
(43) Pub. Date: Oct. 30, 2008

(54) TRACKING USER CLICKS USING AJAX BASED BEACONS

(76) Inventors: Venkateswaran Udayasankar, Sunnyvale, CA (US); Andrew Wooldridge, Redwood City, CA (US)

Correspondence Address: YAHOO! INC.;C/O DREIER LLP, 499 PARK AVENUE, NEW YORK, NY, 10022, US

(21) Appl. No.: 11/741,010

(22) Filed: Apr. 27, 2007

(51) Int. Cl. G06F 17/30

(52) U.S. Cl. 707/10; 707/E17.107

(57) ABSTRACT

The present invention is directed towards systems and methods for tracking user clicks via an asynchronous tracking mechanism. The method according to one embodiment of the present invention comprises receiving a first content item and selecting a hyperlink by a user that the first content item provides. An asynchronous request is submitted indicating selection of the hyperlink and a request is submitted for a second content item. The second content item is loaded in response to an asynchronous acknowledgement indicating completion of the transmission of the request.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The invention disclosed herein relates generally to tracking user interaction across a network. More specifically, the present invention is directed to systems and methods for asynchronously tracking user behavior with an Internet content item.

### BACKGROUND OF THE INVENTION

Monitoring user interaction with a content item, such as a web page, is helpful in determining the return on investment and effectiveness of the content item. If a user is not utilizing a content item, various changes may be made to maximize the exposure of the content item to its intended audience. Monitoring user interaction in traditional markets is a relatively straightforward process; for example, one can measure the market share of a newspaper by determining how many newspapers were sold or of a magazine by how many subscriptions have been ordered. With the advent of digital networked media, such as the Internet, tracking user interaction has become more sophisticated, as well as more important, as the Internet provides a global audience.

Current techniques for monitoring user interaction with search results that a search engine provides tend to be slow and taxing on the server system. For example, one current technique is to redirect users through a search engine's own server. That is, when a user clicks a link on a given search result page, they are first directed to a redirection server that the search engine maintains (for recordation of the link selection) before being redirected to the page they wish to visit. The use of an intermediate redirection server increases the amount of time it takes to return the desired page to the user and therefore degrades the experience of using the search engine, which may result in the loss of users.

The present invention proposes the use of an asynchronous JavaScript and XML (“Ajax”) based beacon to track user clicks, although embodiments of the invention may utilize other asynchronous communication techniques known to those of skill in the art. The present invention uses asynchronous calls to monitor user interaction, as opposed to the synchronous redirection of clients. The use of asynchronous tracking methods allows a search engine (or other provider of content items) to enhance the speed at which pages are served to users by eliminating the “middle man” that is the redirect server. More generally, embodiments of the present invention may be utilized for tracking any user interactions that result in the destruction of a current context and instantiation of a subsequent content, e.g., navigating from a current page to a subsequent page. Furthermore, the use of an Ajax beacon allows the browsing history of the client device to remain in line with the pages they have actually viewed.

### SUMMARY OF THE INVENTION

The present invention is directed towards methods and systems for tracking user clicks via an asynchronous track mechanism. The method of the present invention comprises receiving a first content item, such as a page of search results. After the first content item is received, the user selects a hyperlink that the content item provides, which may correspond to a user click on the hyperlink. An asynchronous request is submitted that indicates selection of the hyperlink and a request is submitted for a second content item in response to the selection of the hyperlink. According to one embodiment, the asynchronous request is made using a JavaScript method. The second content item is loaded in response to an asynchronous acknowledgement indicating completion of the transmission of the request.

The method may further comprise setting a timer interval in response to the selection of the hyperlink and loading the second content item in response to expiration of the timer interval. According to one embodiment, the timer interval corresponds to an estimation of an interval time required for the completion of the transmission of the asynchronous request. Alternatively, the timer interval may correspond to an estimation of a time interval required for the receipt of the request by the server.

The first content item may comprise program code to generate the asynchronous request, which may be a combination of JavaScript program code and which may further comprise structured data, such as XML data. The asynchronous request may contain information regarding selection of the hyperlink. The information regarding the selection of the hyperlink may comprise an identification of the selected link, an identification of the user or an identification of a time at which the link was selected. Information regarding the selection of the hyperlink may be structured in a number of ways know to those of skill in the art. According to one embodiment, the information regarding the selection of the hyperlink is stored within an HTTP request header. Alternatively, or in conjunction, the information regarding the selection of the hyperlink is stored within a URL query string.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram illustrating a system for click tracking according to one embodiment of the present invention;

FIG. 2 is a flow diagram illustrating a method for tracking user clicks using asynchronous and synchronous requests according to one embodiment of the present invention;

FIG. 3 is a flow diagram illustrating the click tracking interaction between a client and server in response to a request timeout according to one embodiment of the present invention; and

FIG. 4 is a flow diagram illustrating the asynchronous click tracking interaction between a client and server according to one embodiment of the present invention.

### DETAILED DESCRIPTION OF THE PREFERRED EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

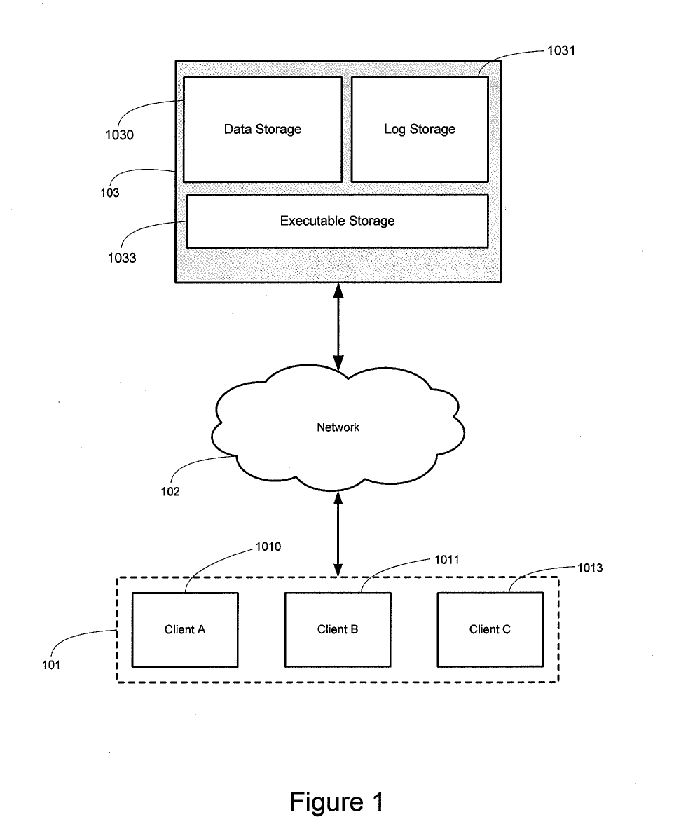

FIG. 1 presents a block diagram illustrating one embodiment of a system for tracking user clicks. According to the embodiment illustrated in FIG. 1, a system for tracking user clicks comprises one or more client devices 1010, 1011 and 1013, one or more networks 102 and one or more content servers 103.

According to the embodiment of FIG. 1, client devices 1010, 1011 and 1013 are communicatively coupled to the network 102, which may include a connection to one or more local and wide area networks, such as the Internet, and may utilize combinations of both wired and wireless media. According to one embodiment of the invention, a client device 1010-1013 is a general purpose personal computer comprising a processor, transient and persistent storage devices operable to execute software such as a web browser, peripheral devices (input/output, CD-ROM, USB, etc.) and a network interface. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

Client devices 1010, 1011 and 1013 are operative to communicate requests to a given content server 103 via the network 102. A given request may be in the form of an HTTP request, RTP request, SOAP request, or any network protocol for requesting content as is known to those of skill in the art. In one embodiment, a client device 1010, 1011 and 1013 may utilize a web browser to request a dynamic built web page comprising search results for one or more requested search terms or phrases.

According to one embodiment, the content server 103 comprises data storage 1030, log storage 1031 and executable storage 1033. The content server 103 may be operative to receive requests from client devices 1010, 1011 and 1013 across the network 102 and to provide content to client devices 1010, 1011 and 1013. Data storage 1030 may comprise HTML pages, JavaScript files, images, audio, video or any static content utilized by a web resource. Log storage 1031 may comprise text files, database tables, or any other data structures known to those of skill in the art for storing information related to user activity. Finally, executable storage 1033 may comprise various program code files that the content server 103 may utilize to generate content items including, but not limited to, PHP files, Perl files or any other program code files known in the art. Although illustrated as separate storage units, the storage units within content server 103 may be combined into one storage unit or may be distributed among different, distinct server units (not shown).

The content server 103 may receive a request for a content item from one or more client devices 1010, 1011 and 1013 and retrieve the content item from data storage 1030. In one embodiment, this content item may be an HTML webpage corresponding to the user request. Alternatively, content server 103 may execute a server side program stored within executable storage 1033 to dynamically generate a content item, such as a dynamically generated HTML file comprising a result set associated with a user search query.

The content item that the content server 103 provides may comprise a plurality of hyperlinks associated links to content items and resources that may be external or internal relative to the content server 103. Additionally, the content server 103 may be operative to process asynchronous requests from the client devices 1010, 1011 and 1013. An asynchronous request may be associated with or encoded into a given hyperlink resident within a responsive content item that the content server 103 provides to a given client device 1010, 1011 and 1013. In accordance with one embodiment, an asynchronous request may be made to the content server 103 upon the generation of a click event on a hyperlink within the returned content item. When the asynchronous request is sent, the given client device 1010, 1011 and 1013 loads the page that the hyperlink identifies.

The content server 103 is operative to receive the asynchronous request from the client devices 101 and generate log data from the request. In accordance with one embodiment, an asynchronous request comprises data related to a user action. For example, the request may contain the link name or any type of link identification. In alternative embodiments, the data related to the user action may further include the time the user selected the link, the identification of a user selecting the link, the referring page or any other parameter related to the user action as is known to those of skill in the art.

After receiving the asynchronous request with associated data, the content server 103 processes the information for logging purposes. In accordance with one embodiment, the content server 103 executes a server side program to parse the received data. This server side program may reside within executable storage 1033. The server side program may be operative to extract the relevant data from the asynchronous request and store the data in an appropriate format within the log storage 1031.

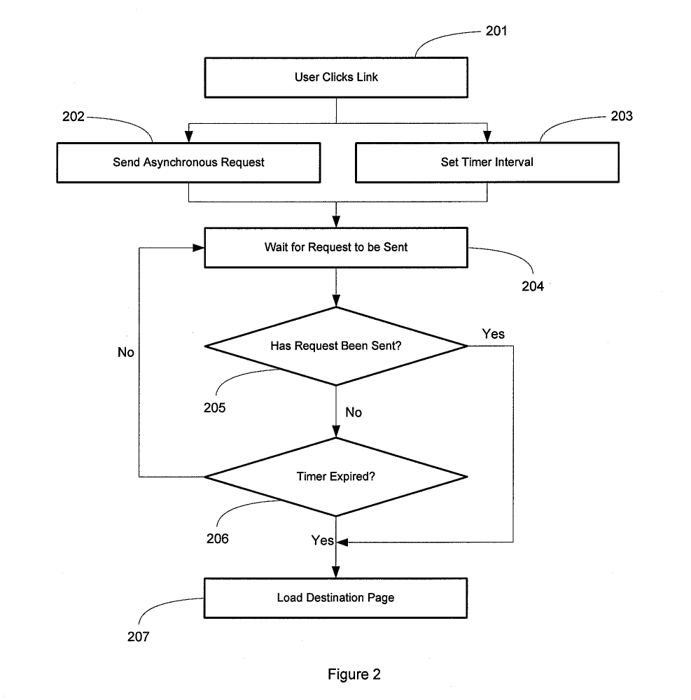

FIG. 2 presents a flow diagram illustrating one embodiment of a method for tracking user clicks using asynchronous and synchronous requests. According to the embodiment illustrated in FIG. 2, a given user may click a link, such as a hyperlink, step 201, which a browser displays as part of a given web page. In accordance with one embodiment, a user is provided with a content item comprising a link to a subsequent content item. For example, a user may query a search engine to retrieve an HTML page containing a result set that comprises links to content items found by the search engine that fall within the scope of the user query. After the search engine transmits the content item to a client browser for display to the user, the user may click a link that the content item contains, such as a link to a content item in a search result page.

When a user clicks a link in the content item, an asynchronous request may be sent to the server, step 202. At substantially the same time, a timer interval is determined or otherwise identified and a timer is activated, step 203. According to one embodiment, the timer interval may correspond to an estimation of time required to complete the transmission of the asynchronous request from the client. For example, an average time for completion of the transmission of a request one second. Accordingly, this value may be selected as the timer interval prior to processing. The asynchronous request may be sent using the XMLHTTPRequest object included with JavaScript. The XMLHTTPRequest object allows JavaScript program code from within (or linked to by) the content item (and executed by the browser) to request data from and provide data to a server without re-loading elements of a current content item. The use of the XMLHTTPRequest object is illustrated by Example 1:

| | |
|---|---|
| 1 | function dummy(data) { |
| 2 | // ... dummy function would go here |
| 3 | } |
| 4 | function AJAXhandler( ) { |
| 5 | if(this.readyState == 4 && this.status == 200) { |
| 6 | if(this.responseXML != null) |
| 7 | dummy(this.responseXML); |
| 8 | } |
| 9 | } |
| 10 | |
| 11 | var newRequest = new XMLHttpRequest( ); |
| 12 | newRequest.onreadystatechange = AJAXhandler; |
| 13 | newRequest.open(“GET”, “data.xml”); |
| 14 | newRequest.send( ); |

### EXAMPLE 1

The JavaScript program code of Example 1 identifies two functions: “dummy” and “AJAXhandler”. The function “dummy” may be operative to perform data processing actions upon the receipt of data. The function “AJAXhandler” may be operative to monitor the state of the asynchronous request, as is described herein in greater detail. On line 11, a new XMLHTTPRequest object is created and stored as a new variable “newRequest”. Line 12 then attaches the user-defined function “AJAXhandler” to the “onreadystatechange” property of the “newRequest” object. The “onreadystatechange” property of the XMLHTTPRequest object is an event listener that monitors the state of the future request. Onreadystatechange is similar in spirit to the event listeners “onmouseover” or “onmousedown,” e.g., they evaluate to true in the present of the event for which the listener is listening. In line 13, a new request is opened using the GET method and specifying the file on the server to retrieve. In example 1, the requested file is shown to be an XML file, however, there is no such limitation on the file that is retrieved by the open( ) method of the XMLHTTPRequest object. According to one embodiment, a server-side script may be requested by the XMLHTTPRequest object (such as a Perl or PHP file, JSON or tab-delimited text). Finally on line 14, the request is sent and the asynchronous transaction begins. Returning again to the function “AJAXhandler,” the code indicates that the function is called when a change is detected in the readyState variable contained within the XMLHTTPRequest object “newRequest”.

In accordance with one embodiment, the value of readyState for an asynchronous request is monitored to determine the appropriate action to be taken. A listing of possible values for the variable readyState are shown in Table 1.

TABLE 1

| readyState | Description |
|---|---|
| 0 | uninitialized |
| 1 | open |
| 2 | sent |
| 3 | receiving |
| 4 | loaded |

As shown in Table 1, an asynchronous request may be monitored to determine when the state of the request (the readyState property) is set to a value of two. This value, corresponding to a “sent” state, signals that the user agent has successfully completed transmission of the request.

As previously stated, when the asynchronous request is sent, a timer interval is set and timer is started (step 203). A timer interval may be chosen to represent the estimated time expected for a user agent to successfully transmit information regarding a user a click to the server. The timer interval is a redundant mechanism to provide functionality in the event of error in transmitting an asynchronous request to the server such that the client fails to enter readyState two. The timer mechanism that the client utilizes may be implemented in JavaScript using any means known to those of skill in the art.

After the transmission of the asynchronous request begins and the timer is started, the process waits for the request to be sent, step 204. As previously stated, in accordance with one embodiment, this may be accomplished by monitoring the change in variable “readyState,” which is part of the XMLHTTPRequest object. If a request has been sent (step 205), the destination page is loaded (step 207); if not, the timer is queried to determine if the asynchronous request has timed out (step 206). If the request is determined to still be active (e.g., the timer has not expired), the process continues to monitor the state of the asynchronous request. If the timer has expired (e.g., transmission of the asynchronous request is taking too much time to complete), the destination page is loaded.

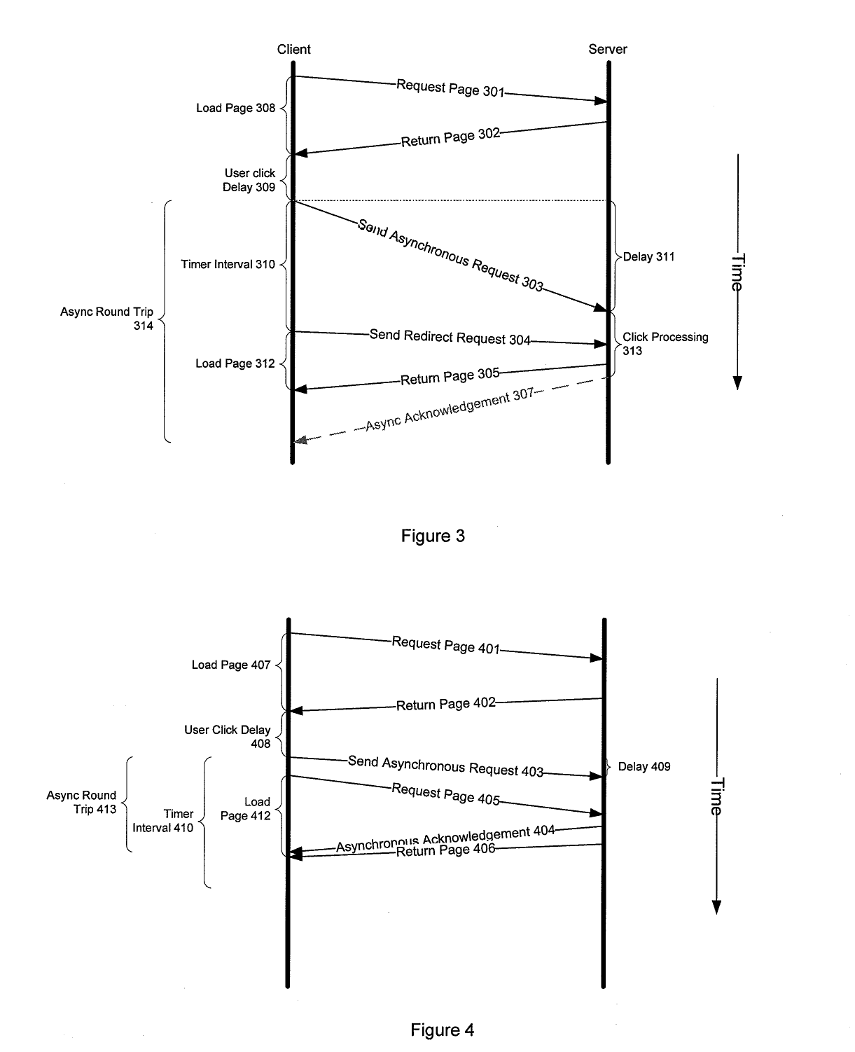

FIG. 3 presents a flow diagram illustrating one embodiment of the interactions between a client and server during a request timeout, e.g., where the client transmits an asynchronous request that does not complete. A client initially requests a content item (301), e.g., a web page, from a server. This request may be an HTTP request resulting from a user submitting a query to a search engine. Alternative embodiments may exist wherein the request may be an HTTP request resulting from a user selecting a hyperlink on a webpage.

The server receives the request and retrieves or generates the appropriate content item that the client requests. The server returns the content item that it retrieves or generates (302), with the corresponding delay between 301 and 302 being equal to the delay experienced by a user upon requesting the content item. Although FIG. 3 illustrates the transaction as one request and response, it is common in the art for multiple requests and responses for a given content item to be made with respect to an initial request, such as the case with external images, scripts, stylesheets and other objects known to those of skill in the art.

After the server returns the content item, a user may spend time browsing the content item, illustrated by “User Click Delay” (309). A user may then select a link by clicking on the appropriate hyperlink that is part of the content item. In response to selection of the hyperlink, an asynchronous request is sent to the server (303), a timer interval is set and a timer begins timing the latency in completing transmission of the request. The length of the timer interval is illustrated as “Timer Interval” (310). As shown in FIG. 3, the asynchronous request is received by the server after a delay (311).

After receiving the asynchronous request, a server may perform server side processing to record the user click (313). In the example provided by FIG. 3, the timer expires prior to receiving an acknowledgement that the transmission of the request is complete (307). The timer may expire prior to receiving the acknowledgement for a variety of reasons such as network traffic delay (illustrated with respect to 311), user modem speed or any other reason for network latency know to those of skill in the art.

When the timer interval 310 expires, an acknowledgement 307 of completion of the transmission of the request has yet to be received by the client, a timeout condition is met and the request for the page associated with the link clicked by the user is sent to a server (304). In accordance with one embodiment, the link that the user requests may not reside on the same server as the server that provided the first page (302) although alternative embodiments may exist wherein all pages are located on the same server. For example, where the requested page (302) is a search results page that the search engines generates, a user click (309) may request a content item in the search result page result set that is on a server that is outside of the domain in which the search engine operates. After the server generates or retrieves the page as it did with respect to request/response (301/302), the server provides the desired page to the client 305.

As can be seen in FIG. 3, the timer interval 310 set on the client side is shorter than the asynchronous request round trip 314. Thus, the timer mechanism provided by the present invention allows the invention to automatically resume the requested operation if it is determined that the asynchronous request is causing unwanted delay in the flow of communication. It should be noted that elements 314 and 307 are presented for reference only, as the asynchronous acknowledgement 307 is not received by the client, nor is the client waiting for the signal as the newly requested page is already loaded.

FIG. 4 presents a flow diagram illustrating one embodiment of the interactions between a client and server during normal operation, e.g., the client device receives acknowledgement of completion of the transmission of the request before the timer expires. A client initially requests a page (401) from a server. As indicated above, this request may be an HTTP request resulting from a user submitting a query to a search engine. Alternative embodiments may exist wherein the request may be an HTTP request resulting from a user selecting a hyperlink on a webpage.

The server receives the request and retrieves or generates the appropriate content item that the client requests. The server returns the retrieved or generated page (302). The corresponding delay 407 between 401 and 402 is equal to the delay experienced by a user upon requesting a page. Although FIG. 4 illustrates the transaction as one request and response, it is common in the art for multiple requests and responses for a given content item to be made with respect to an initial request, such as the case with external images, scripts, stylesheets and other objects known to those of skill in the art.

After the server returns the content item that the user requests, the user may spend time browsing the site, illustrated by “User Click Delay” (408). A user may then select a link by clicking on a hyperlink contained within the content item. As described previously, an asynchronous request is sent to the server (403), a timer interval is set and a timer begins timing the request. The length of the defined timer interval is illustrated as “Timer Interval”. As shown in FIG. 3, the asynchronous request is received by the server after a delay (409).

After sending the asynchronous request, the client may transmit a request for the content item that the selected hyperlink identifies (405). In accordance with one embodiment, the content item that the user requests may not reside on the same server as the server that provided the first page (402) although alternative embodiments may exist wherein all pages are located on the same server. Prior to expiration of the timer interval (410), the client device receives confirmation of the completion of the transmission of the asynchronous request (404). In response to receipt of the confirmation of the completion of the transmission (404), the client device loads the content item that the server returns (406) in response to the content item request (405). As can be seen by the present illustration, the asynchronous round trip time (413) is shorter than the timer interval (410), thus resulting in normal operations of the Ajax beacon

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for tracking user clicks via an asynchronous tracking mechanism, the method comprising:
receiving a first content item;
selecting a hyperlink that the first content item provides;
submitting an asynchronous request indicating selection of the hyperlink and a request for a second content item; and
loading the second content item in response to an asynchronous acknowledgement indicating completion of the transmission of the request.

2. The method of claim 1, further comprising:
setting a timer interval in response to the selection of the hyperlink; and
loading the second content item in response to expiration of the timer interval.

3. The method of claim 2, wherein the timer interval corresponds to an estimation of a interval time required for the completion of the transmission of the asynchronous request.

4. The method of claim 2, wherein the timer interval corresponds to an estimation of a time interval required for receipt of the request by the server.

5. The method of claim 1, wherein the asynchronous request is made through the use of JavaScript program code.

6. The method of claim 1, wherein the first content item corresponds to a search result page that a search engine generates.

7. The method of claim 1, wherein the first content item comprise program code to generate the asynchronous request.

8. The method of claim 7, wherein the asynchronous request contains information regarding selection of the hyperlink.

9. The method of claim 8, wherein the information regarding the selection of the hyperlink comprises an identification of the selected link, an identification of the user or an identification of a time at which the link was selected.

10. The method of claim 9, wherein the information regarding the selection of the hyperlink is stored within an HTTP request header.

11. The method of claim 9, wherein the information regarding the selection of the hyperlink is stored within a URL query string.

12. The method of claim 1, wherein the selection of the hyperlink corresponds to a user click.

13. Computer readable media comprising program code that, when executed by a programmable processor, causes the programmable processor to execute a method for tracking user clicks via an asynchronous tracking mechanism, the program code comprising:
program code for receiving a first content item;
program code for selecting a hyperlink that the first content item provides;
program code for submitting an asynchronous request indicating selection of the hyperlink and a request for a second content item; and
program code for loading the second content item in response to an asynchronous acknowledgement indicating completion of the transmission of the request.

14. The computer readable media of claim 13, further comprising:
program code for setting a timer interval in response to the selection of the hyperlink; and
program code for loading the second content item in response to expiration of the timer interval.

15. The computer readable media of claim 14, wherein the program code for setting the timer interval comprises program code for an estimating a time interval required for the completion of the transmission of the asynchronous request.

16. The computer readable media of claim 14, wherein the program code for setting the timer interval comprises program code for estimating a time interval required for a the receipt of the request by the server.

17. The computer readable media of claim 13, wherein program code for submitting the asynchronous request is made through the use of JavaScript program code.

18. The computer readable media of claim 13, wherein the first content item corresponds to a search result page that a search engine generates.

19. The computer readable media of claim 13, wherein the first content item comprises program code to generate the asynchronous request.

20. The computer readable media of claim 19, wherein the program code for submitting the asynchronous request comprises program code for generating information regarding selection of the hyperlink.

21. The computer readable media of claim 20, wherein the program code for generating information regarding the selection of the hyperlink comprises program code for generating an identification of the selected link, an identification of the user or an identification of a time at which the link was selected.

22. The computer readable media of claim 21, wherein the program code for generating information regarding the selection of the hyperlink comprises program code for storing the information within an HTTP request header.

23. The computer readable media of claim 21, wherein the program code for generating information regarding the selection of the hyperlink comprises program code for storing the information within a URL query string.

24. The computer readable media of claim 13, wherein the program code for selecting the hyperlink comprises program code for receiving a user click of a hyperlink.
